(19) United States
(12) Patent Application Publication
(10) Pub. No.: US 2012/0199580 A1
(43) Pub. Date: Aug. 9, 2012

(54) WAVE STIRRER FOR A MICROWAVE OVEN

(75) Inventors: Abdel-Ilah Zbat, Wurzburg (DE); Markus Breitschwerdt, Rothenburg (DE); Arnd Hofmann, Lulsfeld / Schallfeld (DE); Dagmar Moll, Oberrot (DE)

(73) Assignee: ELECTROLUX HOME PRODUCTS CORPORATION N.V., Brussel (BE)

(21) Appl. No.: 13/498,986

(22) PCT Filed: Jul. 16, 2010
(86) PCT No.: PCT/EP10/04343

§ 371 Date: Mar. 29, 2012

(30) Foreign Application Priority Data
Aug. 20, 2009 (EP) 09010695.6

(51) Int. Cl. H05B 6/74

(52) U.S. Cl. 219/751

(57) ABSTRACT

The present invention relates to a wave stirrer for a microwave oven. The wave stirrer comprises a holding device (10) rotatable around a rotation axis (18) and at least two stirrer blades (12; 26; 28; 34) arranged at the holding device (10). The holding device (10) is made of at least one dielectric material. The stirrer blades (12; 26; 28; 34) are made of at least one conductive material. The maximum axial extension (A) of the stirrer blade (12; 26; 28; 34) along the rotation axis (18) is equal as or bigger than the maximum radial extension (R) of the stirrer blade (12; 26; 28; 34) orthogonal to the rotation axis (18). Further, the present invention relates to a microwave oven with said wave stirrer.

The present invention relates to a wave stirrer with a holding device and at least two stirrer blades for a microwave oven. Further, the present invention relates to a microwave oven comprising at least one wave stirrer with a holding device and at least two stirrer blades.

In household appliances the microwave oven is a very common technology due to its energy efficiency and time savings compared to a conventional oven. The microwaves are reflected by metallic surfaces like the walls of the oven cavity. Thus, interferences cause an uneven distribution of the microwave energy inside the oven cavity, resulting to an uneven heating of food.

In order to get a more even distribution of the microwave energy inside the oven cavity, the microwave oven is equipped with a wave stirrer. Said wave stirrer is rotatable and made of an electrically conductive material. The wave stirrer is arranged inside the oven cavity in such a way that the rotation has a feedback on the magnetron by periodically altering the wave impedance. This results in small frequency shifts of the electro-magnetic field inside the oven cavity. Since the interference pattern depends on the frequency, the resulting areas of high and low field energy are periodically moved through the oven cavity by the wave stirrer.

Besides the desired periodic changes of the wave impedance, it would be advantageous, that the wave stirrer does not increase the reflections of the field energy back to the magnetron. This reflected energy cannot be used for heating the food stuff inside the oven cavity.

The wave stirrer should not have any sharp edges on its surface. Small gaps between the wave stirrer and the metallic surfaces of the oven cavity should be avoided. The sharp edges as well as the small gaps could result in sparks or discharge effects, so that the wave stirrer and the inner wall of the oven cavity can be damaged. A damage of the inner wall of the oven cavity may lead to an unwanted microwave leakage.

The wave stirrers of the prior art often have a complex geometry, which requires a costly production. However, wave stirrers with a simple geometry and small dimensions do not substantially improve the distribution of the electro-magnetic energy, since the feedback on the magnetron is not high enough.

It is the object of the present invention to provide a wave stirrer for a microwave oven, which wave stirrer allows an improved distribution of the electro-magnetic energy on the one hand and has a relative simple geometry on the other hand.

This object is achieved by the wave stirrer for a microwave oven according to claim 1.

According to the present invention the wave stirrer for the microwave oven comprises:
a holding device rotatable around a rotation axis (18), and
at least two stirrer blades arranged at the holding device, wherein
the holding device is made of at least one dielectric material,
the stirrer blades are made of at least one conductive material, and
the maximum axial extension of the stirrer blade along the rotation axis is equal as or bigger than the maximum radial extension of the stirrer blade orthogonal to the rotation axis.

The core of the present invention is the holding device made of the dielectric material on the one hand and the maximum axial extension of the stirrer blade, which is equal as or bigger than the maximum radial extension of the stirrer blade, on the other hand. This constellation results in a lower danger of hot spots and sparkovers. The inventive wave stirrer can be designed in such a way that the wave impedance of the feed-box is improved. Thus, further tuning elements like stubs are not necessary. This results in compact dimensions of the wave stirrer. The production is easy by low costs.

According to the preferred embodiment of the present invention the at least one of the stirrer blades is formed as a sheet, in particular the stirrer blades are formed as plane sheets. This contributes to a simple production. The amount of the required metallic material is low.

In particular, at least two of the stirrer blades are electrically isolated from each other. The electric isolation of the stirrer blades contributes to the lower danger of hot spots and sparkovers.

For example, at least one of the stirrer blades may comprise a cutout, wherein a smaller part of said cutout is complementary with a cross-section of a part of the holding device. These stirrer blades can be easily detached, cleaned and reassembled by the user.

Alternatively, at least one of the stirrer blades may comprise at least one hole and/or at least one slot, wherein the hole and/or the slot, respectively, is connected or connectable to a snap-in mechanism of the holding device. The snap-in mechanism allows that the user can detach the stirrer blades in an easy way.

Preferably, at least one of the stirrer blades is made of at least one metallic material. Further, at least one of the stirrer blades is coated by enamel or ceramic material.

According to the preferred embodiment of the present invention the rotation axis extends along a vertical direction.

Further, the holding device comprises at least two cantilevers, wherein the stirrer blade is attached or attachable at one of the cantilevers.

The cantilever may include at least one mounting groove, so that the cross-section of the cantilever besides said mounting groove is complementary with the smaller part within the cutout of the stirrer blade.

Preferably, the cantilever may include two opposing mounting grooves, so that the cross-section of the cantilever besides said mounting groove is complementary with the smaller part within the cutout of the stirrer blade.

Alternatively, the cantilever may comprise at least one snap-in mechanism complementary with at least one hole and/or at least one slot of the stirrer blade.

Further, the present invention relates to a microwave oven with at least one wave stirrer as described above. Preferably, the microwave oven is provided for a domestic appliance.

The invention will be explained in more detail below by means of exemplary embodiments. Reference is thereby made to the drawings, wherein

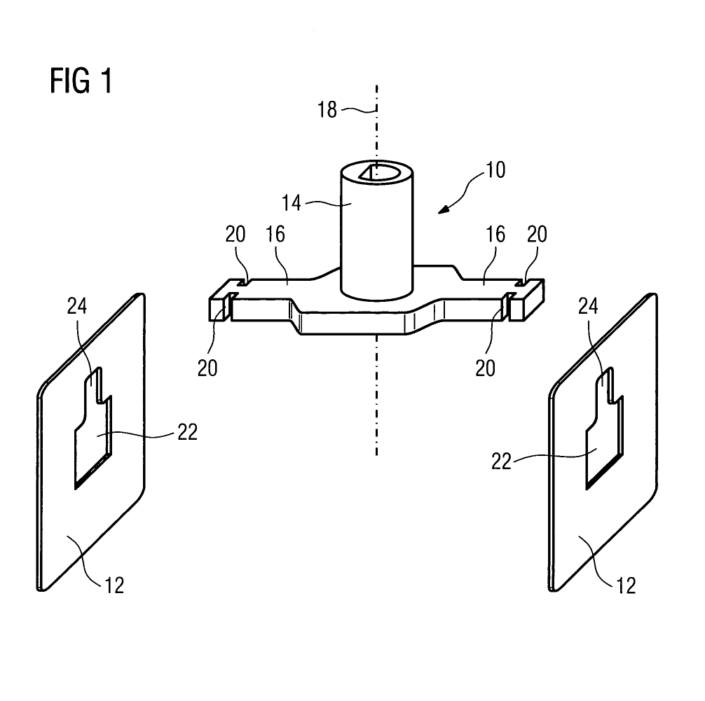

FIG. 1 shows a schematic perspective view of a wave stirrer in a fragmented state according to a first embodiment of the present invention,

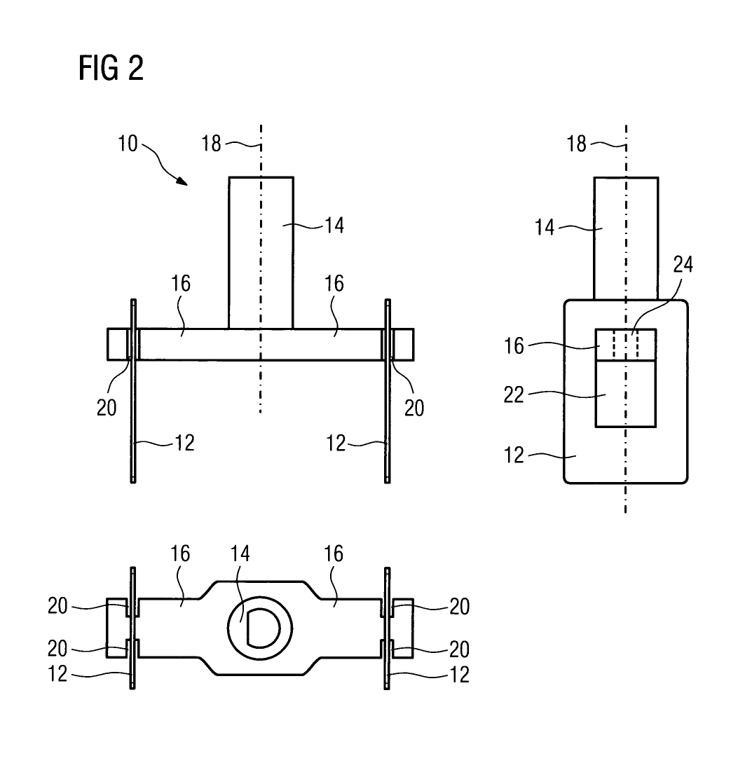

FIG. 2 shows a schematic three-side view of the wave stirrer in a mounted state according to the first embodiment of the present invention,

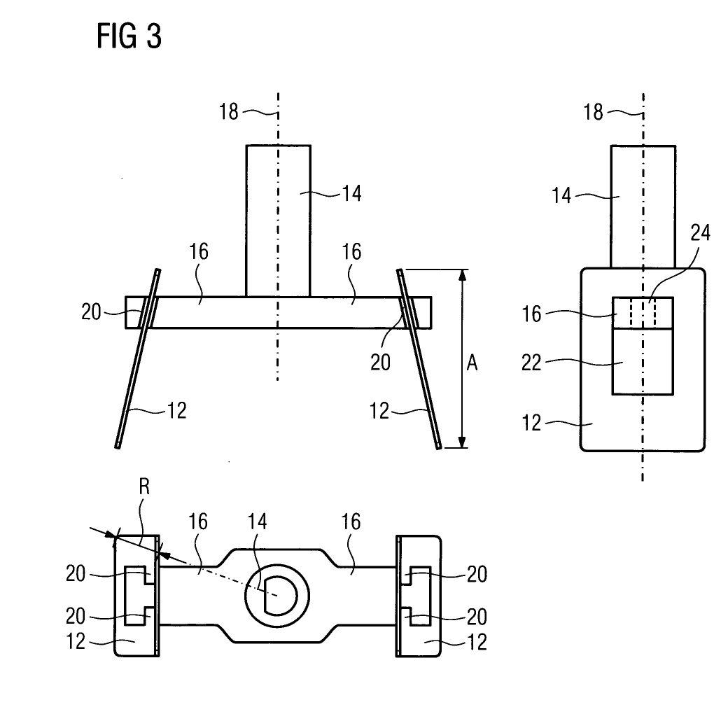

FIG. 3 shows a schematic three-side view of a wave stirrer in a mounted state according to a second embodiment of the present invention,

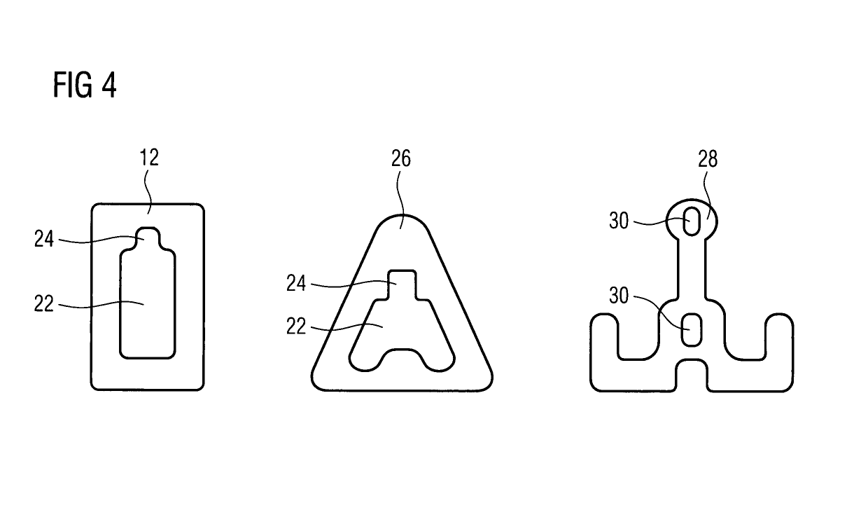

FIG. 4 shows a schematic view of three examples of stirrer blades according to the present invention, and

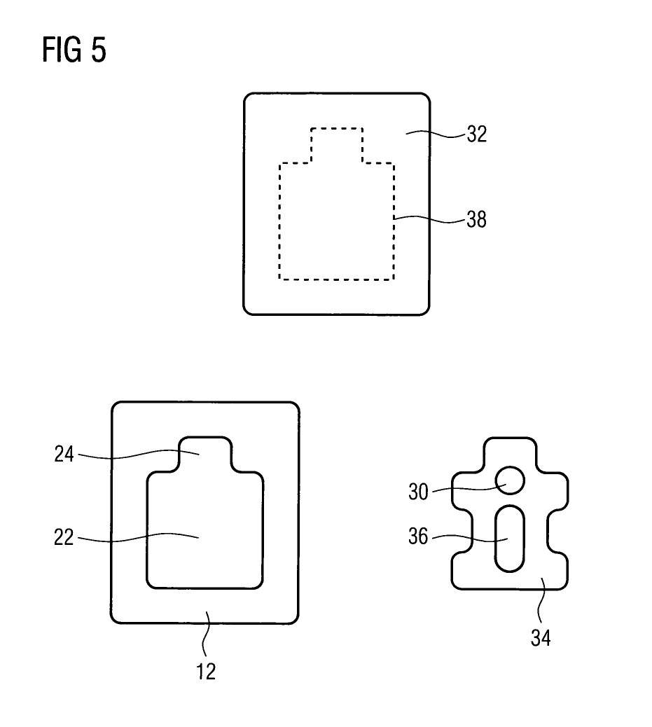

FIG. 5 shows an original sheet provided for a concurrent cutting of two different stirrer blades according to the present invention.

FIG. 1 shows a schematic perspective view of a wave stirrer in a fragmented state according to a first embodiment of the present invention. The wave stirrer comprises a holding device 10 and two stirrer blades 12.

The holding device 10 is made of a dielectric material. Preferably, the holding device 10 consists of ceramics or polymers with a high temperature resistance. For example, the holding device 10 is made of LCP.

The holding device 10 includes a shaft 14 and two cantilevers 16. The shaft 14 extends concentrically along a vertical rotation axis 18. The elongated cantilevers 16 are attached at the lower end of the shaft 14 on opposite sides of said shaft 14. The cantilevers 16 extend perpendicularly to the shaft 14 along a common axis. Each of the cantilevers 16 extends from the rotation axis 18 along a radial direction. In this example both cantilevers 16 are formed as a single-piece part.

In their outer portions the cantilevers 16 include two mounting grooves 20 in each case. The mounting grooves 20 are formed as vertical grooves at side walls of the cantilevers 16. The two mounting grooves 20 of each cantilever 16 are arranged opposite to each other on different side walls of the cantilevers 16.

The stirrer blades 12 are at least partially made of an electrically conductive material. Preferably, the stirrer blades 12 are of at least one metallic material. The stirrer blades 12 can be coated, for example with an enamel or ceramics.

The stirrer blade 12 is formed as a plane sheet and comprises a cutout 22. The cutout 22 is arranged in a central portion of the stirrer blade 12. The cutout 22 includes an upper part 24 with a smaller width than the proper cutout 22. The upper part 24 of the cutout 22 is substantially complementary with the cross-section of the cantilever 16 between the mounting grooves 20. The stirrer blade 12 is provided for hanging at the cantilever 16, wherein the cantilever 16 penetrates the cutout 22 and the upper part 24 of the cutout 22 engages the mounting grooves 20.

FIG. 2 shows a schematic three-side view of the wave stirrer in a mounted state according to the first embodiment of the present invention. The stirrer blades 12 are mounted at the holding device 10 on opposite sides. Each of the two stirrer blades 12 is hanging at one of the two cantilevers 16, respectively. The cantilever 16 penetrates the upper part 24 of the cutout 22. The mounting grooves 20 engage the lateral edges of the upper part 24.

Since the holding device 10 is made of dielectric material, the stirrer blades 12 are electrically isolated from each other. The planes of the stirrer blades 12 extend substantially along an axial direction of the wave stirrer. Thus, the maximum radial extension of the stirrer blade 12 is much smaller than its maximum axial extension.

The radial extension of the stirrer blade 12 is defined as its extension along the radial axis of the wave stirrer, i.e. the extension orthogonal to the rotation axis 18. The axial extension of the stirrer blade 12 is defined as its extension along the radial axis of the wave stirrer, i.e. the extension along the rotation axis 18.

FIG. 3 shows a schematic three-side view of a wave stirrer in a mounted state according to a second embodiment of the present invention. The stirrer blades 12 are mounted at the holding device 10 on opposite sides. Each of both stirrer blades 12 is hanging at one cantilever 16, respectively. The cantilever 16 penetrates the upper part 24 of the cutout 22. The mounting grooves 20 engage the lateral edges of the upper part 24.

Unlike the vertical mounting grooves 20 of the first embodiment in FIG. 1 and FIG. 2, the mounting grooves 20 of the second embodiment in FIG. 3 are inclined, so that the distances of the mounting grooves 20 from the rotation axis 18 increase with a decreasing height. Thus, the planes of the stirrer blades 12 extend also along said inclined direction. However, the radial extension R of the stirrer blade 12 is still much smaller than its axial extension A.

The top view of FIG. 3 clarifies the maximum radial extension R of the stirrer blade 12. The front view of FIG. 3 clarifies the maximum axial extension A of the stirrer blade 12. It is a substantial feature of the present invention, that the maximum axial extension A of the stirrer blade 12 is equal as or bigger than the maximum radial extension R of the stirrer blade 12.

FIG. 4 shows a schematic view of three examples of stirrer blades 12, 26 and 28 according to the present invention. The stirrer blades 12, 26 and 28 are formed as plane sheets.

The first stirrer blade 12 is a rectangular stirrer blade with the cutout 22. The cutout 22 of the first stirrer blade 12 is also substantially rectangular and includes the upper part 24. The width of said upper part 24 is smaller than the width of the proper cutout 22.

The second stirrer blade 26 is a triangular stirrer blade with a substantially triangular cutout 22. The triangular cutout 22 of the second stirrer blade 26 includes the upper part 24. The width of said upper part 24 is smaller than the width of the proper cutout 22.

The upper parts 24 of the first stirrer blade 12 and the second stirrer blade 26 have contours complementary the cross-section of the cantilever 16 between the two opposing mounting grooves 20. Thus, the first stirrer blade 12 and the second stirrer blade 26 can be form-locking plugged into the mounting grooves 20.

The third stirrer blade 28 has a form like an anchor and includes two holes 30. One of the holes 30 is arranged in a central portion of the third stirrer blade 28. The other one of the holes 30 is arranged in an upper portion of the third stirrer blade 28. The holes 30 are provided for such a kind of holding devices with a snap-in mechanism.

FIG. 5 shows an original sheet 32 provided for a concurrent cutting of two different stirrer blades 12 and 34 according to the present invention. The dashed line within the original sheet 32 illustrates a separating line 38 between the different stirrer blades 12 and 34.

The stirrer blade 12 corresponds with the stirrer blade of FIGS. 1 to 3. The stirrer blade 34 is a shaped part with a hole 30 and a slot 36.

The contour of the cutout 22 and the upper part 24 of the stirrer blade 12 is substantially the same as the contour of the stirrer blade 34. The stirrer blades 12 and 34 can be concurrently cut out from the original sheet 32. The geometric structures of the stirrer blades 12 and 34 allow an efficient production of both stirrer blades 12 and 34 from one single piece of sheet, i.e. the original sheet 32.

### LIST OF REFERENCE NUMERALS

10 holding device
12 stirrer blade
14 shaft
16 cantilever
18 rotation axis
20 mounting grove
22 cutout
24 upper part
26 stirrer blade
28 stirrer blade
30 hole
32 original sheet
34 stirrer blade
36 slot
38 separating line

1. A wave stirrer for a microwave oven, which wave stirrer comprises:
a holding device (10) rotatable around a rotation axis (18), and
at least two stirrer blades (12; 26; 28; 34) arranged at the holding device (10), wherein
the holding device (10) is made of at least one dielectric material,
the stirrer blades (12; 26; 28; 34) are made of at least one conductive material, and
the maximum axial extension (A) of the stirrer blade (12; 26; 28; 34) along the rotation axis (18) is equal as or bigger than the maximum radial extension (R) of the stirrer blade (12; 26; 28; 34) orthogonal to the rotation axis (18).

2. The wave stirrer according to claim 1, characterized in that: at least one of the stirrer blades (12; 26; 28; 34) is formed as a sheet.

3. The wave stirrer according to claim 2, characterized in that at least one of the stirrer blades (12; 26; 28; 34) is formed as a plane sheet.

4. The wave stirrer according to claim 1, characterized in that at least two of the stirrer blades (12; 26; 28; 34) are electrically isolated from each other.

5. The wave stirrer according to claim 1, characterized in that at least one of the stirrer blades (12; 26; 28; 34) comprises a cutout (22), wherein a smaller part (24) of said cutout (22) is complementary with a cross-section of a part of the holding device (10).

6. The wave stirrer according to claim 1, characterized in that at least one of the stirrer blades (12; 26; 28; 34) comprises at least one hole (30) and/or at least one slot (36), wherein the hole (30) and/or the slot (36), respectively, is connected or connectable to a snap-in mechanism of the holding device (10).

7. The wave stirrer according to claim 1, characterized in that at least one of the stirrer blades (12; 26; 28; 34) is made of at least one metallic material.

8. The wave stirrer according to claim 1, characterized in that at least one of the stirrer blades (12; 26; 28; 34) is coated by enamel or ceramic material.

9. The wave stirrer according to claim 1, characterized in that the rotation axis (18) extends along a vertical direction.

10. The wave stirrer according to claim 5, characterized in that the holding device (10) comprises at least two cantilevers (16), wherein at least one stirrer blade (12; 26; 28; 34) is attached or attachable at least one cantilever.

11. The wave stirrer according to claim 10 characterized in that at least one cantilever (16) includes at least one mounting groove (20), so that the cross-section of the cantilever (16) besides said mounting groove (20) is complementary with the smaller part (24) within the cutout (22) of the stirrer blade (12; 26; 28; 34).

12. The wave stirrer according to claim 10, characterized in that the at least one cantilever (16) includes two opposing mounting grooves (20), so that the cross-section of the cantilever (16) besides said mounting groove (20) is complementary with the smaller part (24) within the cutout (22) of the stirrer blade (12; 26; 28; 34).

13. The wave stirrer according to claim 10, characterized in that at least one cantilever (16) comprises at least one snap-in mechanism complementary with at least one hole (30) and/or at least one slot (36) of the stirrer blade (12; 26; 28; 34), respectively.

14. A microwave oven with at least one wave stirrer, characterized in that the microwave oven comprises at least one wave stirrer according to claim 1.

15. The microwave oven according to claim 14, characterized in that the microwave oven is provided for a domestic appliance.
